(19) United States
(12) Patent Application Publication
(10) Pub. No.: US 2009/0115164 A1
(43) Pub. Date: May 7, 2009

(54) Mobile cleaning units and systems

(76) Inventors: Annissa Coy, Addy, WA (US); Ron Osborne, Lewiston, ID (US)

Correspondence Address: WELLS ST. JOHN P.S., 601 W. FIRST AVENUE, SUITE 1300, SPOKANE, WA, 99201, US

(21) Appl. No.: 11/983,087

(22) Filed: Nov. 6, 2007

(51) Int. Cl. B62D 53/06

(52) U.S. Cl. 280/433; 134/45

(57) ABSTRACT

Mobile restoration vehicles are provided having at least one axle, with the vehicle comprising a base supported by the axle; walls extending vertically from the base of the vehicle; and a roof supported by the walls, the base, walls, and roof defining at least a portion of the perimeter of the vehicle. The first wall can define an opening configured to receive materials to be restored. Within the perimeter along a second wall an ultrasonic cleaning apparatus can be placed. Along a second wall, opposite the first wall, a contaminated material staging area can be placed. The vehicle can include an ultrasonic cleaning apparatus placed along one wall within the trailer, a staging area along another wall within the trailer, and drying shelves within the above bed portion of the trailer.

### TECHNICAL FIELD

The present disclosure relates to mobile cleaning units and systems.

### BACKGROUND

Disaster settings and as well as non-disaster settings brought about by flood and/or fire, for example, have required decontamination teams moving into areas into which they have not had to move before. Fire and/or flood water damage to the property inside dwellings in the disaster areas can be salvaged and part of this salvage can require cleaning and/or decontamination.

It has proven difficult in the past to mobilize the equipment necessary to clean and/or decontaminate this property and move this equipment to the disaster site. The present disclosure provides mobile decontamination apparatuses and methods of using same such as mobile cleaning units.

### BRIEF DESCRIPTION OF THE DRAWINGS

Preferred embodiments of the invention are described below with reference to the following accompanying drawings.

FIG. 1 is a floor plan of a mobile decontamination apparatus according to an embodiment.

FIG. 2 is a floor plan including dimensions of the apparatus of FIG. 1 according to an embodiment.

FIG. 3 is an interior elevation of the apparatus of FIG. 1 according to an embodiment.

FIG. 4 is an interior elevation of FIG. 3 including dimensions according to an embodiment.

FIG. 5 is an interior elevation of the mobile apparatus of FIG. 1 according to an embodiment.

FIG. 6 is the elevation of FIG. 5 including dimensions according to an embodiment.

### DESCRIPTION

This disclosure is submitted in furtherance of the constitutional purposes of the U.S. Patent Laws “to promote the progress of science and useful arts” (Article 1, Section 8).

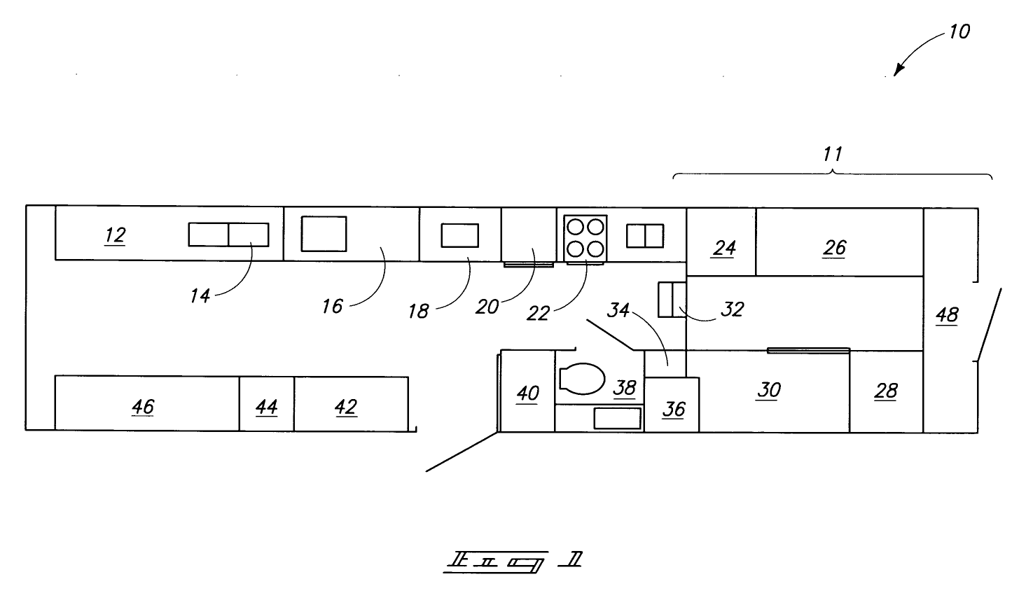

The mobile restoration apparatus of the present disclosure will be described with reference to FIGS. 1-6. Referring to FIG. 1, mobile apparatus 10 can be a trailer, either a dual wheeled trailer or what is referred to as a fifth-wheel trailer. The trailer itself can have a weight of approximately 21,000 lbs. and an approximate square footage of not more than 300 sq. ft. Exemplary trailers include those manufactured by Forest River Trailers, Inc. According to exemplary embodiments, the trailer itself can include a rear door allowing for access directly to the rear of the trailer. The door can be oversized, in fact as large as five to six feet wide or larger. The door itself can be of the roll-up variety and/or it can be the classic swing-open door.

The trailer itself can contain cleaning equipment such as an ultrasonic cleaner as well as an ozone room and a drying room. The trailer itself can have a base supported by an axle and then walls extending vertically above the axle from the base of the vehicle. A roof can be supported by the walls, with the base, walls, and roof defining at least a portion of the perimeter of the vehicle with the first wall defining an opening configured to receive materials to be restored.

Along the perimeter of the trailer along the second wall can be placed an ultrasonic cleaning apparatus such as ultrasonic cleaning apparatus 16, for example. An example ultrasonic cleaning apparatus can be the Omega Fire Pro 3600, produced and sold by Omegasonics Corporation. Apparatus 16 can have a size of 36 inches in length, 18 inches in width, and 20 inches in depth, with an overall dimension of 59 inches in length, 21 inches in width, and 34 inches in height.

Along a second wall opposite the first wall the trailer, a contaminated material staging area 46 can be placed with the opening providing access to both the ultrasonic cleaning apparatus and the staging area. According to another embodiment, along the first wall described above at least a sink 18 can be placed proximate the ultrasonic cleaning apparatus. According to another embodiment, along the first wall, two sinks can be placed with the ultrasonic cleaning apparatus 16 being between a double sink 14 and a sink 18. Along a second wall and opposite the ultrasonic cleaning apparatus a computer area 44 proximate the contaminated material staging area 46 can be placed. Vehicle 10 can have an above-bed portion 11. This is typically the area on fifth-wheel trailers that is above the pick-up truck bed that hauls the trailer. Within this above-bed portion, drying shelves 24 may be placed as well as a box storage area 26. Along the front of the trailer and having an access door thereto, an ozone room 48 can be placed, and a portion below the bed portion can be configured to house utility components such as generators, hot water heaters, compressors, and the like in area 28. Vehicle 10 may also include a drying room 30 that may be placed proximate a dehumidifier 36. Closet for storage 40 may be placed next to a lavatory 38 and an extra, smaller closet 34. Steps 32 can be provided to an access area to the above-bed portion of vehicle 10. Vehicle 10 may likewise include a kitchenette area including a stove 22 and a refrigerator 20. Additional contaminated counter area 12 may be provided towards the rear access point or fold-down access door of vehicle 10.

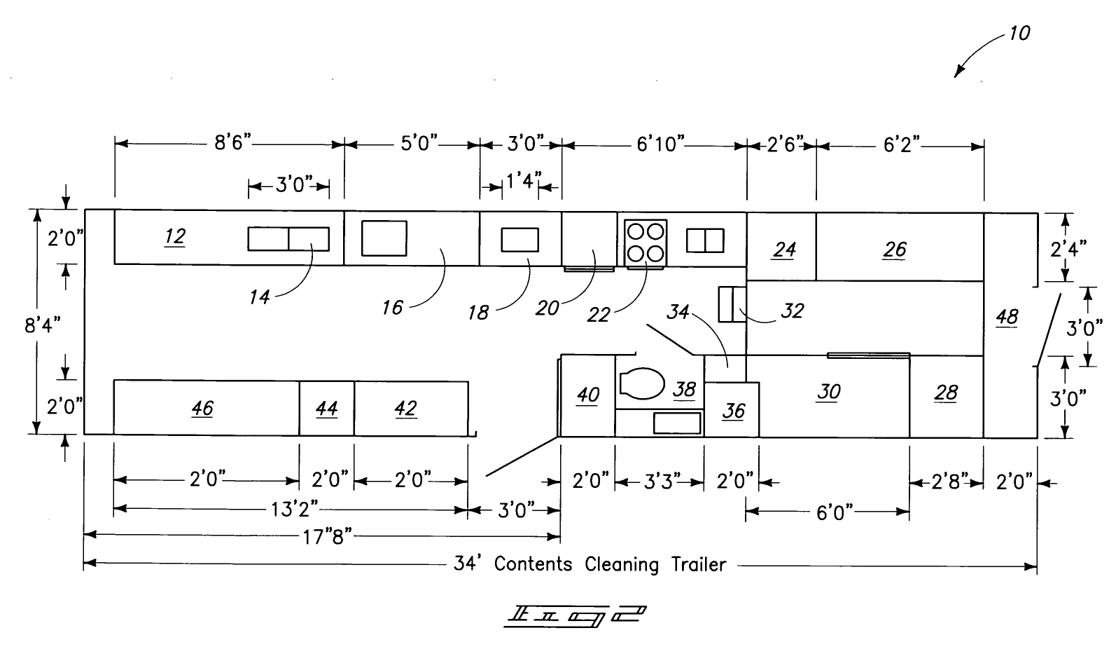

Referring to FIG. 2, exemplary dimensions of vehicle 10 are provided. These dimensions are meant for example purposes only, and the scope and contents of the present disclosure, particularly the claims, should not be limited to such dimensions.

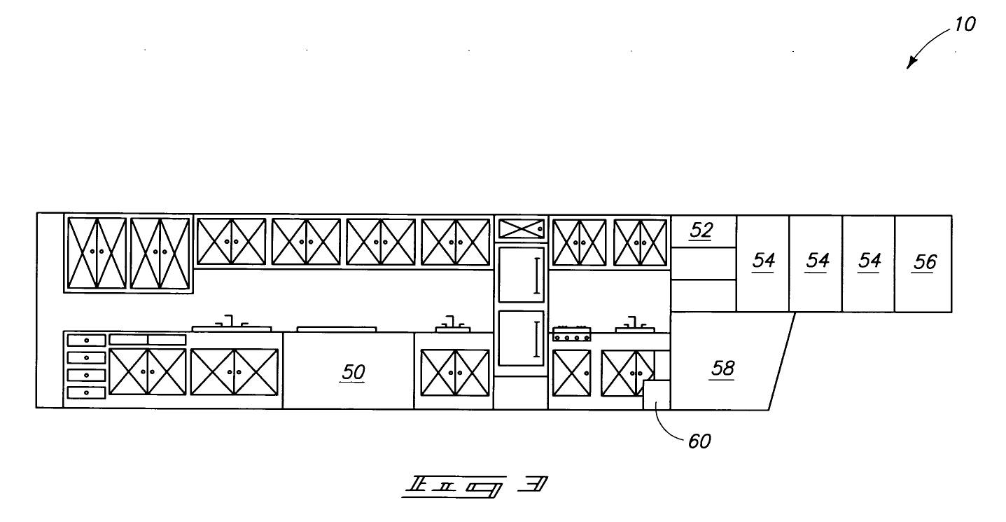

Referring to FIG. 3, an elevation of apparatus 10 is shown according to an embodiment. Ultrasonic cleaner 50 is placed along this elevation and also includes box rack 52 as well as box storage areas 54 and ozone room 56. Propane tanks and storage in the utility rooms 58 are also shown. A cross-section of steps 60 heading up to the above storage compartment area is shown as well.

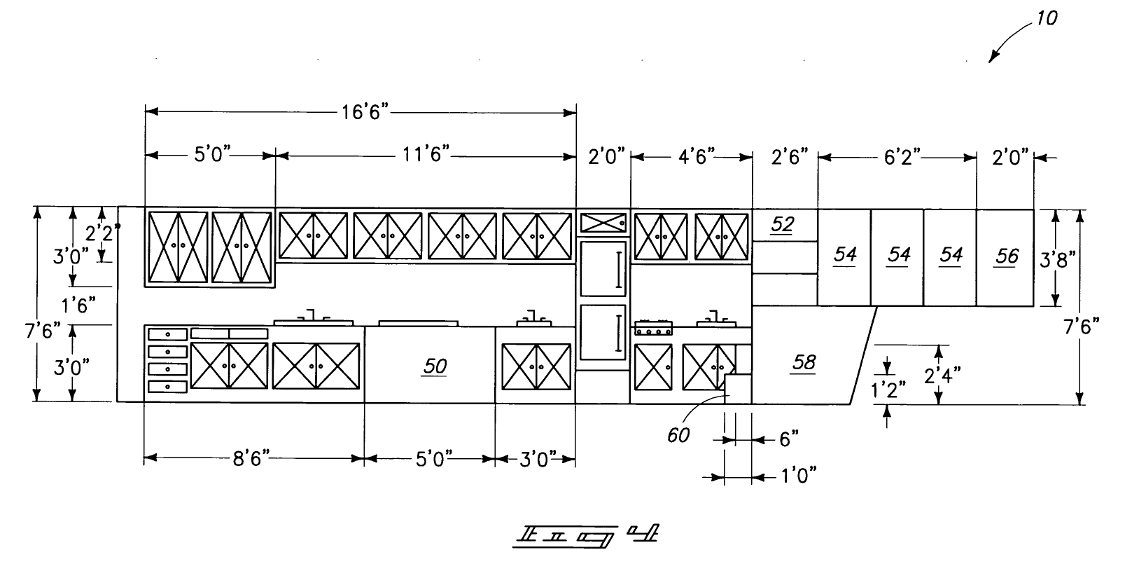

Referring to FIG. 4, detailed dimensions of these components with relation to this elevation are shown as well. Again, the subject matter of the disclosure should not be limited to these dimensions.

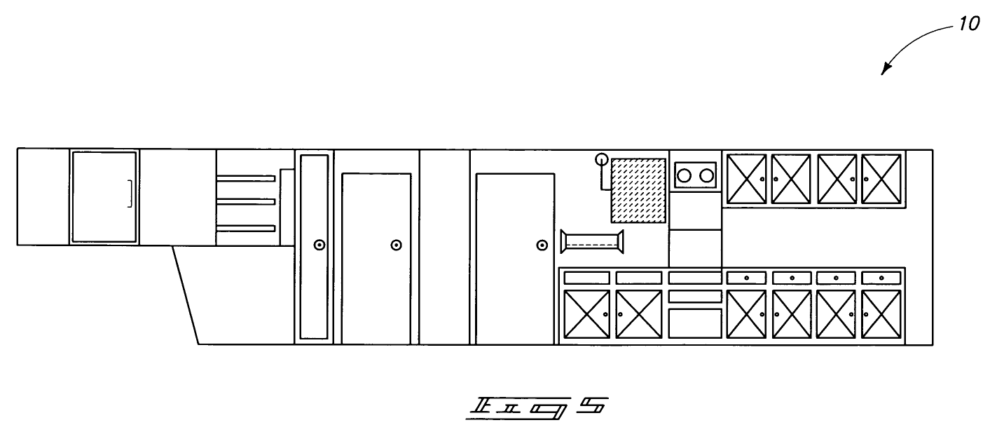

Referring to FIG. 5, another elevation of vehicle 10, the opposing elevation to the previous elevation, is shown.

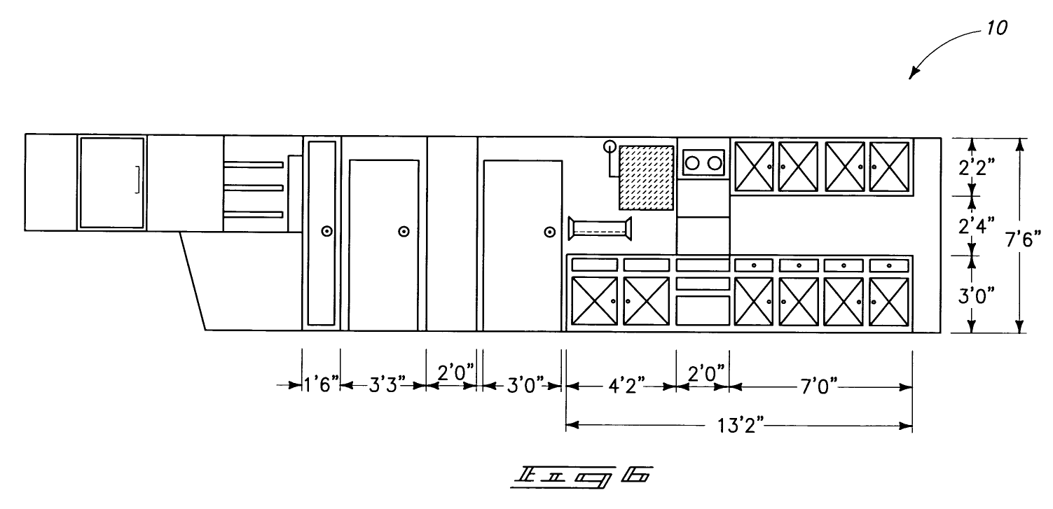

Referring to FIG. 6, an elevation including dimensions of elevation of FIG. 5 is shown in FIG. 6. Again, the subject matter of the disclosure should not be limited to these dimensions.

According to exemplary embodiments, a process for restoring materials can include providing contaminated materials to within mobile restoration vehicle 10. The process can also include ultrasonically cleaning the contaminated materials within the restoration vehicle, drying the cleaned materials within the vehicle, and then finally removing the cleaned materials from the vehicle.

According to exemplary embodiments, the contaminated materials can be provided to within the mobile restoration vehicle through a rear opening in the restoration vehicle. As another implementation, the contaminated materials can be staged on one side of the restoration vehicle before being ultrasonically cleaned on the opposing side of the vehicle. The process can also include, upon ultrasonically cleaning materials on one side of the vehicle, drying the cleaned materials in a forward portion of the vehicle. The method can also include ozonizing the materials before removing the materials from the vehicle.

According to yet another embodiment, the mobile restoration vehicle cleaning platform can include an ultrasonic cleaning apparatus along a first wall, a staging area along a second wall, with the first wall opposing the second wall. A computer area can also be part of the restoration vehicle proximate the staging area, and a packing area can be proximate the computer desk, with the computer area being between the staging area and the packing area. The vehicle can also include a drying area proximate both the ultrasonic cleaning apparatus and the packing area. According to an exemplary embodiment, the restoration vehicle platform can be based on the shape of a triangular pattern with the ultrasonic cleaning apparatus, the staging area and the drying area being arranged at different corners of the triangular pattern. According to another embodiment, the triangular pattern can include an ultrasonic cleaning apparatus, a computer area, and a drying area being placed at different corners of the triangular pattern. In yet another implementation, the ultrasonic cleaning apparatus, the staging area and the packing area can be arranged at different corners of the triangular pattern.

A quadrangular pattern for components within the vehicle can also be utilized. For example, the ultrasonic cleaning apparatus, the staging area, the computer area, and the drying area can be arranged in a quadrangular pattern with each of these components being placed at different corners of the quadrangular pattern. According to an exemplary implementation, the quadrangular pattern can include as well a staging area that is adjacent the computer area that is part of the quadrangular pattern. The present disclosure provides the arrangement of these components within a vehicle that is lightweight as well as easily mobilized to disaster areas. The arrangements of the components within the trailer itself allow for the user to quickly and efficiently move contaminated materials through the trailer and provide efficient cleaning of the materials and restoration of the materials.

In compliance with the statute, embodiments of the invention have been described in language more or less specific as to structural and methodical features. It is to be understood, however, that the entire invention is not limited to the specific features and/or embodiments shown and/or described, since the disclosed embodiments comprise forms of putting the invention into effect. The invention is, therefore, claimed in any of its forms or modifications within the proper scope of the appended claims appropriately interpreted in accordance with the doctrine of equivalents.

1-9. (canceled)

10. A process for restoring materials comprising: providing contaminated materials to within a mobile restoration vehicle, the mobile restoration vehicle having a weight of less than 21,000 lbs.;
ultrasonically cleaning the contaminated materials within the restoration vehicle;
ozonizing the cleaned materials before removing from the vehicle;
drying the cleaned materials within the vehicle; and
removing the cleaned materials from the vehicle.

11. A process for restoring materials as claimed in claim 10, and wherein the contaminated materials are provided to within the mobile restoration vehicle through a rear opening in the restoration vehicle.

12. A process for restoring materials as claimed in claim 10, and wherein the contaminated materials are staged on one side of the restoration vehicle before being ultrasonically cleaned on an opposing side of the vehicle.

13. A process for restoring materials as claimed in claim 10, and wherein, upon being ultrasonically cleaned on one side of the vehicle the cleaned materials are dried at a forward portion of the vehicle.

14-20. (canceled)
